(19) United States
(12) Patent Application Publication
(10) Pub. No.: US 2017/0172717 A1
(43) Pub. Date: Jun. 22, 2017

(54) Dental Carrier

(71) Applicants: Taipei Medical University, Taipei City (TW); Industrial Technology Research Institute, Hsinchu County (TW)

(72) Inventors: WIN-PING DENG, TAIPEI CITY (TW); HENG-YU LIU, TAIPEI CITY (TW); HSIN-HUA CHOU, TAIPEI CITY (TW); CHIN-YU TSAI, TAIPEI CITY (TW); CHIUNG-FANG HUANG, TAIPEI CITY (TW); CHUN-HSIANG WEN, TAIPEI CITY (TW); PING-CHEN CHEN, TAIPEI CITY (TW); CHING-SUNG CHEN, Hsinchu CITY (TW); CHENG-HUSAN LIN, Hsinchu CITY (TW); KAI-HAN LIAO, Hsinchu CITY (TW)

(21) Appl. No.: 15/385,817

(22) Filed: Dec. 20, 2016

(30) Foreign Application Priority Data
Dec. 22, 2015 (TW) 104143087

(51) Int. Cl. A61C 19/06

(52) U.S. Cl. CPC A61C 19/066; A61C 2201/00

(57) ABSTRACT

A dental carrier comprises a thermoplastic carrier. The thermoplastic carrier has a pattern structure. After heating the thermoplastic carrier, the thermoplastic carrier is provided with a user to be impressed by teeth or alveolar ridge for forming teeth or alveolar ridge model of the user. Compared to the prior art, the dental carrier of the present invention can provide the dental medicament contained in the pattern structure to be precisely applied and hold onto the treatment area and the medicament can be evenly coated on the teeth, root, or periodontal tissue for the treatment of teeth. When the dental carrier is not used to carry medicament, the pattern structure can improve the mechanical strength and fitness of the dental carrier to be used as a biteplate, orthodontic retainer, periodontal dressing for treatment or protection or mouth guard in sports.

### BACKGROUND OF THE INVENTION

1. Field of the Invention

The present invention relates to a dental carrier, and more particularly, to a dental carrier for shaping the correct and suitable shape according to the dentition and leading the loading (medicament or dental hygiene health and beauty related materials) to be evenly and precisely coated on the teeth, root, gum or periodontal tissue to be treated.

2. Description of the Prior Art

The medicament such as antibiotics used in periodontal treatment or dental hygiene health and beauty related materials, such as fluoride gel and whitening medicament, are often needed to be coated on the teeth, root surface and gum tissue of the mouth by using tools. Currently, the tools used on the market commonly are brush, cotton rolls, or dental tray. The medicaments are often interfered or diluted by the tongue or saliva flow using these tools, and the medicaments also move away from the area to be coated in the mouth with the effect of gravity or the position of the teeth. Furthermore, the conventional cotton rolls or dental trays are loosely attached to the teeth, thereby often resulting in inconvenience and uncomfortable to the user, reducing the effect of the medicament and increasing the dosage of the medicament.

The conventional dental tray is a carrier that places medicament or dental hygiene health and beauty related materials (such as whitening medicament and fluoride coating), and the medicament or the hygiene related materials can be confined to the space near the teeth by the carrier. Currently, there is a kind of dental tray, and the principle of the dental tray is to use the characteristic that the thermoplastic material can be any deformation after heating. Thus, one may heat the dental tray and then use the solid teeth to set the shape while the thermoplastic material has not yet completely cooled, therefore the dental tray can be created correctly and suitably according to different individuals, so that the dental tray can be firmly adhered to the surrounding teeth. However, the present design makes the gap between the dental tray and the convex surface of the teeth surface very small, and the gap between the teeth gap and the concave surface of the teeth root becomes large, so that the medicament or the hygiene health related materials cannot be evenly coated on the area to be treated (such as the teeth surface or the teeth root), and the medicament also flows away from the area to be coated with the gravity or the position of the teeth in the mouth, thereby resulting in inconvenience to the user (the medicament coating people and coated people), uncomfortable situation, the reducing effect of the medicament and the increasing dosage of the medicament.

The U.S. Pat. No. 5,562,449, 5,616,027 and 5,769,633 belong to a series of dental tray patents, and the concept of a double-layer dental tray provided by these prior arts has a horseshoe-shaped exterior and an U-shaped cross section that are similar to the arrangement of human teeth shape, and the outer tray is a resilient material that can be used to support the inner tray; the inner tray is a thermoplastic material and the inner tray becomes more plastic when being heated to 145-160° F., therefore, when the patients press the inner tray with the teeth, a more accurate dentition shape can be printed out.

Besides, the ROC Patent No. M441456 proposes a dental tray-type oral health care film, and the technical characteristic is a double-layer dental tray comprising a thin layer and a shaping layer, wherein the thin layer can comprise a medicament or other dental care materials for contacting the teeth, and the shaping layer can be shaped in accordance with the individual dentition for allowing the thin layer to be firmly adhered to the teeth.

However, in the prior art, when the medicament for treating the teeth is coated in the molded double-layer dental tray, because the dental tray is too closely adhered to the teeth surface, the medicament cannot be guided to the area to be treated and is hard to be evenly coated on the area to be treated.

### SUMMARY OF THE INVENTION

Therefore, to solve the above-mentioned problems, the present invention provides a dental carrier for shaping the correct and suitable shape according to the teeth or alveolar ridge of the human to be firmly adhered to the teeth, and the amount of space between the teeth and the dental carrier can be adjusted in a suitable area of the dental carrier by the design of the pattern structure to lead the loading (medicament or hygiene health and beauty related materials) to be evenly and precisely coated on the teeth, periodontal tissue, alveolar ridge or area to be treated, while the dental carrier can also meet the needs to be firmly adhered to the teeth, therefore the dental carrier can improve the effectiveness of treatment. When the dental carrier is not used to carry the medicament, the pattern structure can improve the mechanical strength and fitness of the dental carrier to be used as a mouth guard in sports, biteplate, periodontal dressing, teeth fixation, orthodontic retainer or protection for the teeth, root, periodontal tissue or alveolar ridge.

The dental carrier of the present invention comprises: a thermoplastic carrier, having a surface, wherein the surface has a pattern structure. After heating the thermoplastic carrier, the thermoplastic carrier is provided with a user to bite or impress by the user's teeth or alveolar ridge, and the thermoplastic carrier is formed into the dental carrier that covers the user's teeth or alveolar ridge.

Wherein, the dental carrier can apply the medicament to the surface after impressed or formed the shape when in use, and allow the user to wear the dental carrier to apply the medicament to the user's teeth, root or periodontal tissue.

In an embodiment of the present invention, an exterior of the thermoplastic carrier is an elongated shape and a cross-sectional shape of the elongated shape comprises a circular shape, an elliptical shape and a rectangular shape.

In an embodiment of the present invention, the pattern structure is selected from a group comprising a cavity structure, a trench structure and a convex structure and any combination thereof.

In an embodiment of the present invention, the cavity structure comprises a plurality of cavities, and the trench structure comprises a plurality of trenches, and the gaps between the edges of the cavities and the edges of the trenches are less than 5 mm.

In an embodiment of the present invention, the cavity structure comprises a plurality of cavities, and the trench structure comprises a plurality of trenches, and a depth of the cavities and the trenches into the thermoplastic carrier is at least 0.1 mm.

In an embodiment of the present invention, the shape of the cavity structure comprises a triangular shape, a circular shape, a square shape, an elliptical shape and a polygonal shape, and an arrangement of the cavity structure comprises a honeycomb arrangement, a linear arrangement and an irregular arrangement, and a cross-sectional shape of the trench structure comprises a zigzag shape, a semi-circular shape, an upside-down U shape, a semi-elliptical shape and a non-closed polygonal shape.

In another embodiment of the present invention, the dental carrier further comprises an outer tray, wherein the outer tray has an accommodation space for accommodating the thermoplastic carrier.

In another embodiment of the present invention, the exterior of the outer tray is a horseshoe shape, and the cross section of the outer tray is a U shape, and the exterior of the thermoplastic carrier is a horseshoe shape, and the cross section of the thermoplastic carrier is an U shape, and the surface of the thermoplastic carrier is the inner surface of the U shape cross section.

In another embodiment of the present invention, the accommodation space further has an accommodation space surface, and the thermoplastic carrier further has an outer surface, and the outer surface is partly adhered to the accommodation space surface, or the outer surface is totally fixed to the accommodation space surface by the exterior and a frictional force.

Compared to the prior art, the dental carrier of the present invention can provide the dental medicament contained in the pattern structure to be precisely applied and hold onto the surface of the treatment area and the medicament can be evenly coated on the teeth, root, or periodontal tissue for the treatment of teeth. When the dental carrier is not used to carry medicament, the pattern structure can improve the mechanical strength and fitness of the dental carrier to be used as a mouth guard in sports, biteplate, periodontal dressing, teeth fixation, orthodontic retainer or protection for the teeth, root, periodontal tissue or alveolar ridge.

The advantages and spirits of the invention may be understood by the following recitations together with the appended drawings.

### BRIEF DESCRIPTION OF THE APPENDED DRAWINGS Some of the embodiments will be described in detail, with reference to the following figures, wherein like designations denote like members, wherein:

FIG. 1 shows a schematic diagram of the dental carrier in an embodiment of the present invention.

FIG. 2 (A) to (B) shows an exploded diagram of the dental carrier in an embodiment of the present invention.

FIG. 3 (A) to (C) shows a schematic diagram of the pattern structure respectively in an embodiment of the present invention.

FIG. 4 shows a cross-section diagram crossing along to the I-I line in FIG. 2A of the thermoplastic carrier.

FIG. 5 shows a schematic diagram of the thermoplastic carrier in another embodiment of the present invention.

FIG. 6 (A) to (C) shows a schematic diagram of the dental carrier respectively in another embodiment of the present invention.

FIG. 7 (A) to (C) shows a cross-section diagram crossing along to the line in FIG. 6A of other exterior of the dental carrier in another embodiment of the present invention.

FIG. 8 (A) to (D) shows a schematic diagram of the experimental results of the effective coating range of the thermoplastic carrier not provided with a pattern structure.

FIG. 9 (A) to (D) shows a schematic diagram of the experimental results of the effective coating range of the thermoplastic carrier provided with a pattern structure—cavity structure.

FIG. 10 (A) to (D) shows a schematic diagram of the experimental results of the effective coating range of the thermoplastic carrier provided with a pattern structure—trench structure.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

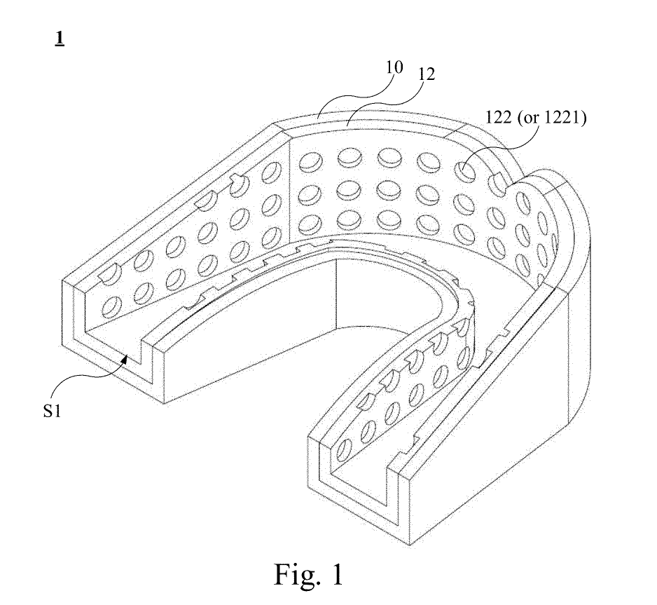

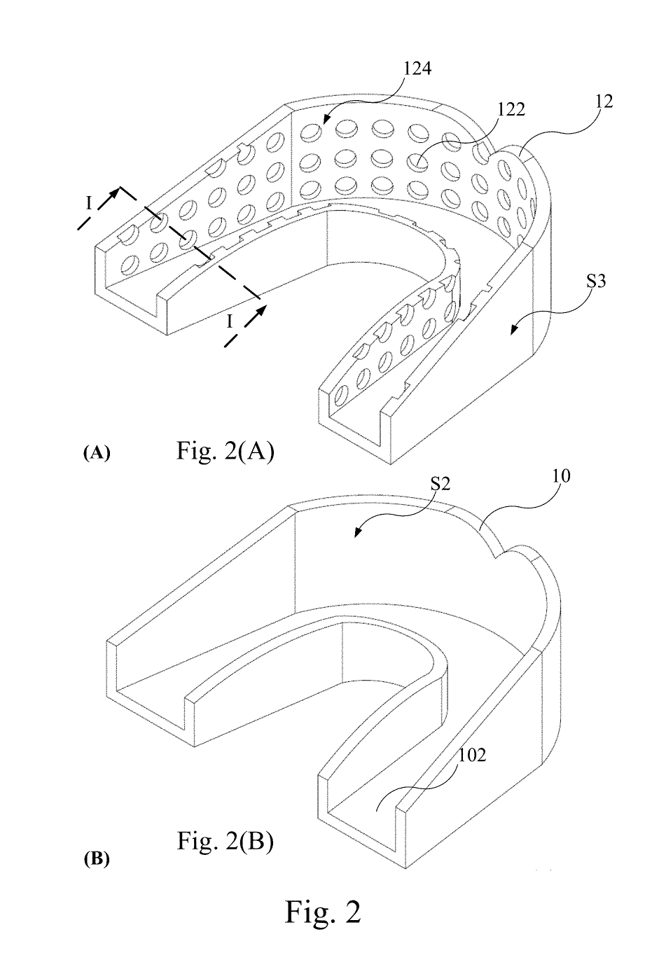

Please refer to FIG. 1 and FIG. 2. FIG. 1 shows a schematic diagram of the dental carrier in an embodiment of the present invention. FIG. 2 (A) to (B) shows an exploded diagram of the dental carrier in an embodiment of the present invention. The present invention provides a dental carrier 1, wherein the dental carrier comprises an outer tray 10 and a thermoplastic carrier 12. The thermoplastic carrier 12 can be used alone or be used with the outer tray 10. The outer tray 10 has an accommodation space 102 for accommodating the thermoplastic carrier 12, and the thermoplastic carrier 12 comprises an inner surface S1, wherein the inner surface Si has a pattern structure 122. Wherein, FIG. 2 (A) illustrates the thermoplastic carrier 12, and FIG. 2 (B) illustrates the outer tray 10.

Wherein, as shown in FIG. 2 (A) to (B), the exterior of the outer tray 10 is a horseshoe shape, and the cross section of the outer tray 10 is a U shape, and the exterior of the thermoplastic carrier is the horseshoe shape, and the cross section of the thermoplastic carrier is the U shape. The outer tray 10 further has an accommodation space surface S2, and the thermoplastic carrier 12 further has an outer surface S3, wherein the outer surface S3 is partly adhered to the accommodation space surface S2 or totally fixed to the accommodation space surface S2 by the exterior and a frictional force.

Wherein, the thermoplastic carrier is selected from a group comprising ethylene vinyl acetate (EVA), polyethylene (PE), polypropylene (PP), polyester (POLYESTER), polyvinyl chloride (PVC), polystyrene (PS), polymethylmethacrylate (PMMA) , Polycarbonate (PC), polyethylene terephthalate (PET), nylon (nylon), polytetrafluoroethylene (PTFE), polyurethane (PU), polyoxymethylene (POM), porous materials and the combination thereof.

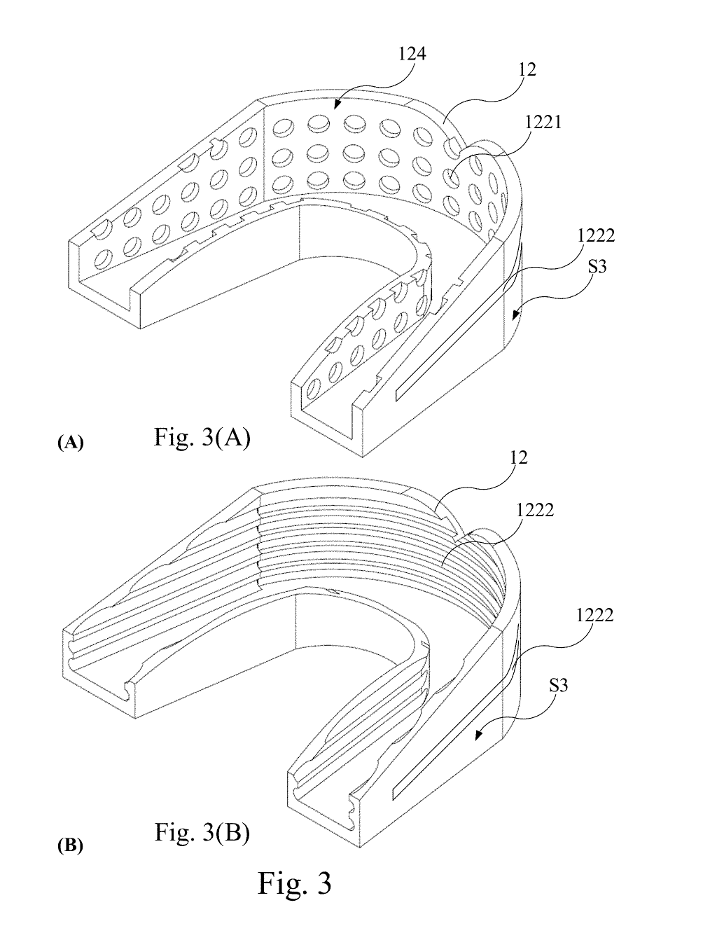

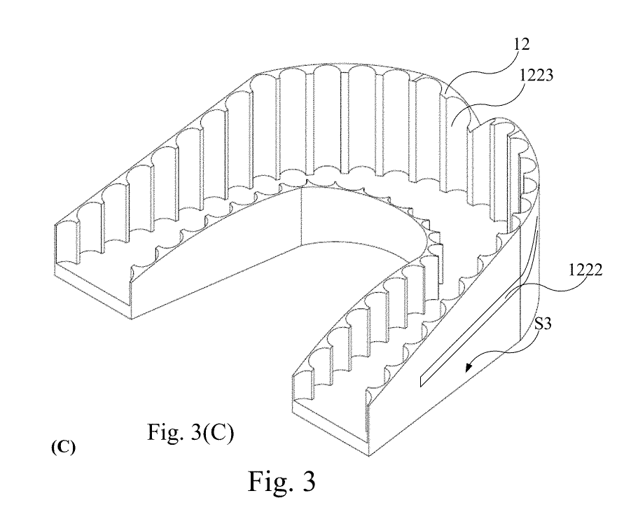

Furthermore, as shown in FIG. 3 (A) to (C), FIG. 3 (A) to (C) shows a schematic diagram of the pattern structure respectively in an embodiment of the present invention. The inner surface S1 of the thermoplastic carrier 12 has a sidewall 124, and the pattern structure 122 is configured on the sidewall 124. In the present invention, the pattern structure 122 comprises a cavity structure 1221, as shown in FIG. 3 (A), and a trench structure 1222. The trench structure comprises two embodiments, one is a lateral trench structure 1222 as shown in FIG. 3 (B), and the other one is a longitudinal trench structure 1223 as shown in FIG. 3 (C). In the practical application, the pattern structure 122 can be selected from a group comprising the cavity structure 1221, the lateral trench structure 1222 and the longitudinal trench structure 1223 and any combination thereof; however, the present invention is not limited to it, in addition to the above-mentioned lateral trench structure 1222 and longitudinal trench structure 1223, the trench structure can also comprise an oblique trench structure, a helical trench structure, and a serrated trench structure.

In an embodiment of the present invention, when the cavity structure 1221 is used as the pattern structure 122, the thermoplastic carrier 12 can be heated with the outer tray 10 after the dental carrier 1 is synthesized from the thermoplastic carrier 12 and the outer tray 10, or the thermoplastic carrier 12 can be heated alone, for example, after the thermoplastic carrier 12 is heated to be soft, the surface of the thermoplastic carrier 12 is slightly cooled in few seconds, and then a user will put the dental carrier 1 into the mouth to be impressed by teeth or alveolar ridge, so that the dental carrier 1 can form teeth or alveolar ridge model of the user to achieve the effect of the present invention.

Next, fill the inner surface S1 comprising the cavity structure 1221 with a medicament to be applied to the teeth, root, alveolar ridge or periodontal tissue to allow the user to directly impress the present invention, so that the teeth, root, alveolar ridge or periodontal tissue can be closed to the inner surface S1 comprising the cavity structure 1221, and the medicament can be uniformly applied to the teeth, root, alveolar ridge or periodontal tissue of the user. Wherein, the medicament comprises a whitening medicament, a mouthwash, and a medicament for the treatment or maintenance of teeth, root, alveolar ridge or periodontal tissue.

The shape of the cavity structure 1221 comprises a triangular, circular, square, elliptical and polygonal shape. In addition to the arrangement shown in FIG. 3(A), the arrangement of the cavity structure further comprises a honeycomb arrangement.

Please refer to FIG. 3 (B) to (C) again. In another embodiment of the present invention, the dental carrier 1 uses the lateral trench structure 1222 and the longitudinal trench structure 1223 as the pattern structure 122 respectively, as shown in FIG. 3 (B) and FIG. 3 (C) respectively. The cross-sectional shape of the lateral trench structure 1222 and the longitudinal trench structure 1223 is semi-circular shape. However, the cross-sectional shape of the trench structure comprises a zigzag shape, a semi-circular shape, an upside-down U shape, a semi-elliptical shape and a non-closed polygonal shape. In the embodiment of the present invention, the same as mentioned above, the thermoplastic carrier 12 can be heated with the outer tray 10 after the dental carrier 1 is synthesized from the thermoplastic carrier 12 and the outer tray 10, or the thermoplastic carrier 12 can be heated along, after the surface of the thermoplastic carrier 12 is slightly cooled, a user will put the dental carrier 1 into the mouth to be impressed by teeth or alveolar ridge, so that the dental carrier 1 can form teeth or alveolar ridge model of the user to achieve the effect of the present invention.

Next, fill the inner surface S1 comprising the lateral trench structure 1222 or the longitudinal trench structure 1223 with a medicament to be applied to the teeth, root, alveolar ridge or periodontal tissue to allow the user to directly impress the present invention, so that the teeth, root, alveolar ridge or periodontal tissue can contact with the inner surface S1 comprising the lateral trench structure 1222 or the longitudinal trench structure 1223, and the medicament can be evenly applied to the teeth, root, alveolar ridge or periodontal tissue of the user. Wherein, the medicament comprises a whitening medicament, a mouthwash, and a medicament for the treatment or maintenance of teeth, root, alveolar ridge or periodontal tissue.

In the above-mentioned embodiment, the thermoplastic carrier 12 must be used with the outer tray 10 in the dental carrier 1, but in the practical application, the thermoplastic carrier 12 can also be directly used as the dental carrier 1 of the present invention, so that the outer tray 10 is not required at this time. The user can use the thermoplastic carrier 12 coated with the medicament and having been customized by the user to be impressed by teeth directly as shown in FIG. 3 (A) to (C).

Furthermore, the pattern structure 122 can also be formed on the outer surface S3 of the thermoplastic carrier 12, as shown in FIG. 3 (A) to (C), in the embodiment of the present invention, the lateral trench structure 1222 is formed on the outer surface S3, for the sake of the clean and clear of the figures, only one lateral trench structure 1222 is drawn on the outer surface S3 as the representative, in the practical application, a plurality of lateral trench structures 1222 or other types of the pattern structures 122 can be formed on the outer surface S3. Wherein each trench of the trench structure formed on the outer surface S3 belongs to a closed trench or culvert to avoid the leakage of the medicament from the trench structure to the outer surface S3; while the trench structure formed on the sidewall 124 is open trench or open channel.

The pattern structure 122 formed on the outer surface S3 of the thermoplastic carrier 12 is connected to the pattern structure 122 on the inner surface S1 by a perforation (not shown in figures) for the purpose of medicament guidance, take FIG. 3 (A) for example, the lateral trench structure 1222 is connected to the cavity structure 1221 on the inner surface S1 by a perforation running through the sidewall 124 (not shown in figures), in the embodiment of the present invention, the user can place the medicament in the lateral trench structure 1222 on the outer surface S3, so that the medicament can be led to the cavity structure 1221 on the inner surface S1 via the perforation, thereby allowing the medicament to be led to the area to be treated such as teeth, root or periodontal tissue. Otherwise, the thermoplastic carrier 12 can be formed from a porous material, thereby allowing the medicament to be led to the cavity structure 1221 on the inner surface S1 from the lateral trench structure 1222 on the outer surface S3 via the porosity of the material of the thermoplastic carrier 12.

The above-mentioned pattern structure 122 has the function of storing the medicament and leading the medicament to the area to be treated such as teeth, root or periodontal tissue. In the practical application, the user can only apply the medicament on the partial pattern structure 122 to treat the partial position of the teeth, root or periodontal tissue of the user. However, the pattern structure 122 of the present invention is not necessary to be covered the sidewall 124 or the outer surface S3 all over, and the design of the present invention also allows the pattern structure 122 to be formed on the sidewall 124 or the outer surface S3, for example, the thermoplastic carrier 12 only forms the pattern structure 122 on the sidewall 124 corresponding to the left molar, right molar or both molars of the user, so that the dental carrier 1 becomes a kind of dental carrier to coat the medicament on the molars of the user.

In an embodiment of the present invention, the user can also use the dental carrier 1 through putting the dental carrier 1 into the mouth without coating the medicament, for example, during intense exercise including various ball games and boxing, various fighting techniques, close combat, integrated fighting techniques training and competition, the user can wear the present invention as a mouth guard. Otherwise, the dental carrier 1 of the present invention is used as a bite plate to treat bruxism or tempromandibular joint related problems. Otherwise, the dental carrier 1 of the present invention is used as a periodontal dressing after periodontal surgery. Otherwise, the dental carrier 1 of the present invention is used as a dental retainer after orthodontic treatment.

As shown in FIGS. 2 (A) to 3 (C), in a better embodiment of the present invention, the gaps between the edges of each cavity of the cavity structure 1221 and the edges of each trench of the lateral trench structure 1222 and the longitudinal trench structure 1223 are less than 5 mm, preferably less than 3 mm. The depth of each cavity of the cavity structure 1221 and each trench of the lateral trench structure 1222 and the longitudinal trench structure 1223 into the sidewall 124 are at least 0.1 mm preferably.

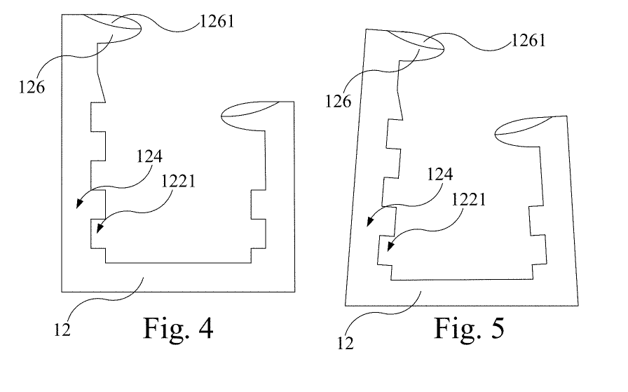

Please refer to FIG. 4 and FIG. 5. FIG. 4 shows a cross-section diagram crossing along to the I-I line in FIG. 2A of the thermoplastic carrier. FIG. 5 shows a schematic diagram of the thermoplastic carrier in another embodiment of the present invention. The dental carrier 1 of the present invention is designed so that the width of the thermoplastic carrier 12 is uniform, as shown in FIG. 4. However, in order to allow the thermoplastic carrier 12 to be adapted more closely to the teeth, root or periodontal tissue of the user, another design of the present invention is to let the inner and outer sidewalls 124 of the thermoplastic carrier 12 are inclined toward each other, as shown in FIG. 5. The thermoplastic carrier 12 further comprises a convex structure 126, and the convex structure 126 is configured on the upper half of the sidewall 124 and comprises a convex structure groove 1261, as shown in FIG. 4 and FIG. 5.

Wherein, in the embodiments of FIG. 4 and FIG. 5, the convex structure 126 extends in mutual direction towards each another, but the user or the manufacturer can also extend the convex structure 126 in the direction of the sidewall 124 of the thermoplastic carrier 12, in such cases, the direction of arrangement of the convex structure groove 1261 is in the same direction as the pattern structure 122. The convex structure groove 1261 has the same effect as the patterned structure 122, and the convex structure groove 1261 is adapted to apply the medicament in the convex structure groove 1261, so that the medicament can contact with the root or periodontal tissue of the user to be coated on the root or periodontal tissue.

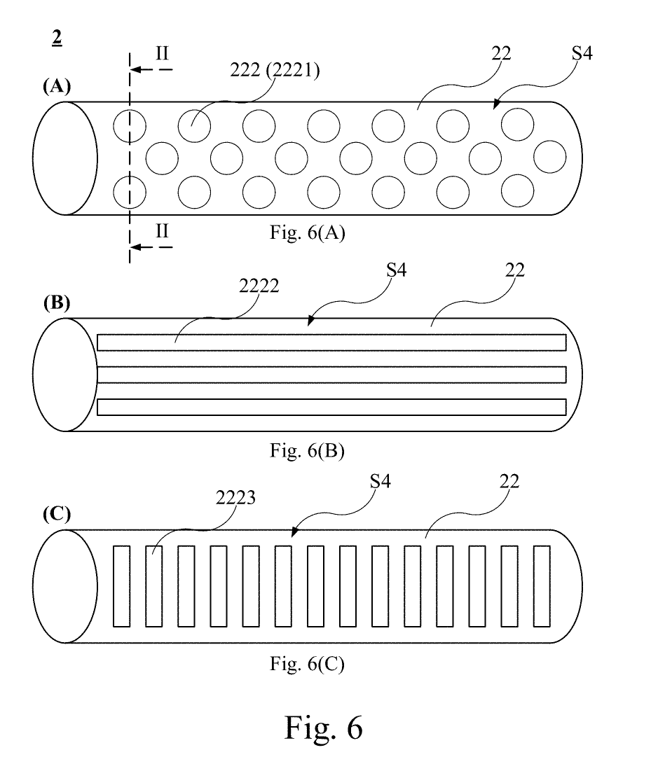

Please refer to FIG. 6 (A) to (C). FIG. 6 (A) to (C) shows a schematic diagram of the dental carrier respectively in another embodiment of the present invention. The present invention further provides another dental carrier 2, and the dental carrier 2 comprises a thermoplastic carrier 22, and the thermoplastic carrier 22 comprises a surface S4, wherein the surface S4 has a pattern structure 222.

Wherein, the pattern structure 222 comprises three embodiments: the cavity structure 2221, the lateral trench structure 2222 and the longitudinal trench structure 2223, as shown in FIG. 6 (A) to (C) respectively. However, the present invention is not limited to it, in addition to the lateral trench structure 2222 and the longitudinal trench structure 2223, the trench structure can also comprise an oblique trench structure, a helical trench structure, and a serrated trench structure.

Wherein, before using the present invention, the thermoplastic carrier 22 needs to be heated, for example, the thermoplastic carrier 22 is heated and softened in the hot water, and the thermoplastic carrier 22 is taken out, after the surface of the thermoplastic carrier 12 is slightly cooled, a user will put the dental carrier 2 into the mouth to be bent according to the shapes of dentition of the user, so that the thermoplastic carrier 22 can be impressed on the surface of the teeth or the alveolar ridge to be shaped, and the surface S4 of the thermoplastic carrier 22 having the pattern structure 222 needs to be oriented towards the teeth of the user, with respect to the relative position, the surface S4 having the pattern structure 222 is similar to the inner surface S1 of the thermoplastic carrier 12 of the dental carrier 1 in function.

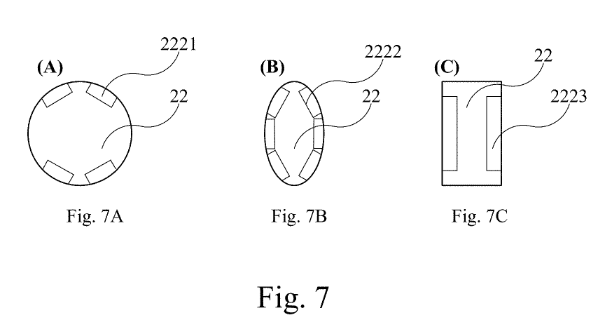

Please refer to FIG. 6 and FIG. 7 at the same time. FIG. 7 (A) to (C) shows a cross-section diagram crossing along to the II-II line in FIG. 6A of other exterior of the dental carrier in another embodiment of the present invention. As shown in FIG. 6 (A) to (C), the exterior of the thermoplastic carrier 22 is an elongated shape and the cross-sectional shape of the elongated shape is circular, but the present invention is not limited to it, the cross-sectional shape of the elongated thermoplastic carrier 22 also comprises an elliptical shape and a rectangular shape, as shown in FIG. 7 (A) to (C).

The purpose of the pre-use work mentioned above is to allow the thermoplastic carrier 22 to be formed in the shape of the teeth or the alveolar ridge of the user to achieve the customization effect of the present invention.

Next, fill the inner surface S4 comprising the pattern structure 222 with a medicament to be applied to the teeth, root, alveolar ridge or periodontal tissue to allow the user to directly impress the present invention, so that the teeth, root, alveolar ridge or periodontal tissue can contact with the inner surface S4 comprising the pattern structure 222, and the medicament can be uniformly applied to the teeth, root, alveolar ridge or periodontal tissue of the user. Wherein, the medicament comprises a whitening medicament, a mouthwash, and a medicament for the treatment or maintenance of teeth, root, alveolar ridge or periodontal tissue.

The above-mentioned pattern structure 222 has the function of storing the medicament and leading the medicament to the area to be treated such as teeth, root or periodontal tissue. In the practical application, the user can only apply the medicament on the partial pattern structure 222 to treat the partial position of the teeth, root or periodontal tissue of the user. However, the pattern structure 222 of the present invention is not necessary to be covered the surface S4 all over, and the design of the present invention also allows the pattern structure 222 to be formed on the surface S4, for example, the thermoplastic carrier 22 only forms the pattern structure 222 on the surface S4 corresponding to the left molar, right molar or both molars of the user, so that the dental carrier 2 becomes a kind of dental carrier to coat the medicament on the molars of the user.

As shown in FIG. 6 (A) to (C), in a better embodiment of the present invention, the gaps between the edges of each cavity of the cavity structure 2221 and the edges of each trench of the lateral trench structure 2222 and the longitudinal trench structure 2223 are less than 5 mm, preferably less than 3 mm. The depth of each cavity of the cavity structure 2221 and each trench of the lateral trench structure 2222 and the longitudinal trench structure 2223 into the surface S4 are at least 0.1 mm preferably.

In an embodiment of the present invention, the user can also use the dental carrier 2 through putting the dental carrier 2 into the mouth without coating the medicament, for example, during intense exercise including various ball games and boxing, various fighting techniques, close combat, integrated fighting techniques training and competition, the user can wear the present invention as a mouth guard. Otherwise, the dental carrier 2 of the present invention is used as a bite plate to treat bruxism or tempromandibular joint related problems.

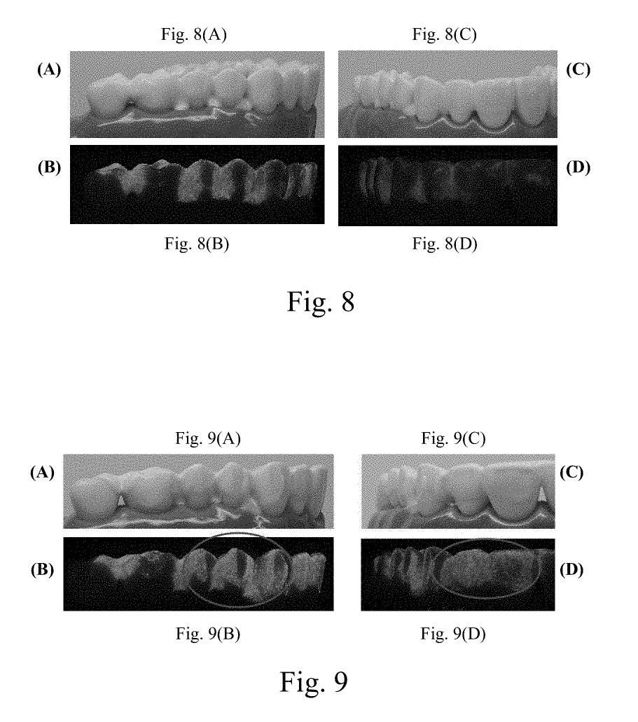

Finally, please refer to FIG. 8 to FIG. 10. The inventors have experimentally verified the effective coating range of the pattern structure 12 formed on the inner surface S1 of the thermoplastic carrier 12.

Please refer to FIG. 8 (A) to (D). FIG. 8 (A) to (D) shows a schematic diagram of the experimental results of the effective coating range of the thermoplastic carrier not provided with a pattern structure. Wherein, FIG. 8 (A) and FIG. 8 (B) are the experimental photos before and after closing the light source to each other, the same as FIG. 8 (C) and FIG. 8 (D). The present invention applies a fixed amount (0.6 ml) of luminous gel to the thermoplastic carrier 12 been impressed in the shape of the individual dentition without the pattern structure 122, and the false teeth were put on the thermoplastic carrier 12. Next, carefully take out the false teeth to prevent the false teeth from touching the side wall 124 of the thermoplastic carrier 12 and the false teeth coated with the luminous gel is irradiated for 5 minutes under the light and then the ambient light is turned off to take the distribution of the luminous gel under the fixed exposure time by the digital camera, as the control group to determine the advantages and disadvantages of uniformity. The luminous gel is used to simulate medicament or dental health care beauty materials, in order to observe the coating uniformity.

Please refer to FIG. 9 (A) to (D). FIG. 9 (A) to (D) shows a schematic diagram of the experimental results of the effective coating range of the thermoplastic carrier provided with a pattern structure—cavity structure. Wherein, FIG. 9 (A) and FIG. 9 (B) are the experimental photos before and after closing the light source to each other, the same as FIG. 9 (C) and FIG. 9 (D). The present invention applies a fixed amount (0.6 ml) of luminous gel to the thermoplastic carrier 12 been impressed in the shape of the individual dentition with the pattern structure 122, namely the cavity structure 1221, and the false teeth were put on the thermoplastic carrier 12. Next, carefully take out the false teeth to prevent the false teeth from touching the side wall 124 of the thermoplastic carrier 12 and the false teeth coated with the luminous gel is irradiated for 5 minutes under the light and then the ambient light is turned off to take the distribution of the luminous gel under the fixed exposure time by the digital camera, after comparing FIG. 8 with FIG. 9, it can be found that the thermoplastic carrier 12 having the cavity structure 1221 (the pattern structure 122) provides better uniformity of application of the luminous gel than the thermoplastic carrier 12 without the pattern structure 122. Wherein, the cavity structure 1221 of the embodiment has a diameter of 4 mm and a depth of 3 mm.

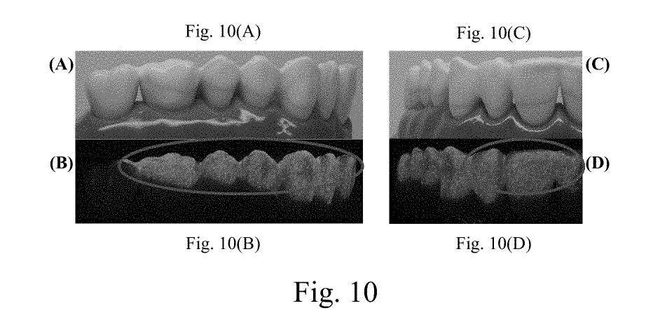

Please refer to FIG. 10 (A) to (D). FIG. 10 (A) to (D) shows a schematic diagram of the experimental results of the effective coating range of the thermoplastic carrier provided with a pattern structure—trench structure. Wherein, FIG. 10 (A) and FIG. 10 (B) are the experimental photos before and after closing the light source to each other, the same as FIG. 10 (C) and FIG. 10 (D). The present invention applies a fixed amount (0.6 ml) of luminous gel to the thermoplastic carrier 12 been impressed in the shape of the individual dentition with the pattern structure 122, namely the longitudinal trench structure 1223, and the false teeth were put on the thermoplastic carrier 12. Next, carefully take out the false teeth to prevent the false teeth from touching the side wall 124 of the thermoplastic carrier 12 and the false teeth coated with the luminous gel is irradiated for 5 minutes under the light and then the ambient light is turned off to take the distribution of the luminous gel under the fixed exposure time by the digital camera, after comparing FIG. 8 with FIG. 10, it can be found that the thermoplastic carrier 12 having the longitudinal trench structure 1223 (the pattern structure 122) provides better uniformity of application of the luminous gel than the thermoplastic carrier 12 without the pattern structure 122. Wherein, the longitudinal trench structure 1223 of the embodiment has a diameter of 4 mm and a depth of 3 mm.

According to the experimental results of FIG. 8 to FIG. 10, the dental carrier of the present invention has considerably superior coating uniformity through having the thermoplastic carrier 12 with the pattern structure 122 compared to the thermoplastic carrier 12 without the pattern structure 122.

In conclusion, the present invention provides a dental carrier comprising a thermoplastic carrier and also provides another dental carrier comprising a thermoplastic carrier and an outer tray, wherein the thermoplastic carrier has a pattern structure. By heating the thermoplastic carrier before using, the carrier becomes easily to be molded, after the thermoplastic carrier is slightly cooled, the user bites the dental carrier or impresses the dental carrier onto the teeth or alveolar ridge, so that the carrier can be formed in the shape of the teeth or the alveolar ridge of the user to achieve the effect of customization. Next, apply a medicament to the surface of the carrier and allow the user to wear the dental carrier to apply the medicament to the teeth, root or periodontal tissue of the user.

Compared with the prior art, the dental carrier of the present invention can lead the medicament to the area to be treated and allow the medicament to be evenly and accurately coated on the teeth, root or periodontal tissue by the designed pattern structure to achieve the efficacy of treating or protecting the teeth, root, alveolar ridge or periodontal tissue.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A dental carrier, comprising:
a thermoplastic carrier, having a surface, wherein the surface has a pattern structure.

2. The dental carrier of claim 1, wherein an exterior of the thermoplastic carrier is an elongated shape and a cross-sectional shape of the elongated shape comprises a circular shape, an elliptical shape and a rectangular shape.

3. The dental carrier of claim 1, wherein the pattern structure is selected from a group comprising a cavity structure, a trench structure and a convex structure and any combination thereof.

4. The dental carrier of claim 3, wherein the cavity structure comprises a plurality of cavities, and the trench structure comprises a plurality of trenches, and the gaps between the edges of the cavities and the edges of the trenches are less than 5 mm.

5. The dental carrier of claim 3, wherein the cavity structure comprises a plurality of cavities, and the trench structure comprises a plurality of trenches, and a depth of the cavities and the trenches into the thermoplastic carrier is at least 0.1 mm.

6. The dental carrier of claim 3, wherein the shape of the cavity structure comprises a triangular shape, a circular shape, a square shape, an elliptical shape and a polygonal shape, and an arrangement of the cavity structure comprises a honeycomb arrangement, a linear arrangement and an irregular arrangement, and a cross-sectional shape of the trench structure comprises a zigzag shape, a semi-circular shape, an upside-down U shape, a semi-elliptical shape and a non-closed polygonal shape.

7. The dental carrier of claim 1, wherein the thermoplastic carrier is selected from a group comprising ethylene vinyl acetate (EVA), polyethylene (PE), polypropylene (PP), polyester (POLYESTER), polyvinyl chloride (PVC), polystyrene (PS), polymethylmethacrylate (PMMA) , Polycarbonate (PC), polyethylene terephthalate (PET), nylon (nylon), polytetrafluoroethylene (PTFE), polyurethane (PU), polyoxymethylene (POM), porous materials and any combination thereof.

8. The dental carrier of claim 1, further comprising an outer tray, wherein the outer tray has an accommodation space for accommodating the thermoplastic carrier.

9. The dental carrier of claim 8, wherein the exterior of the outer tray is a horseshoe shape, and a cross section of the outer tray is a U shape, and the exterior of the thermoplastic carrier is a horseshoe shape or a part of the horseshoe shape, and a cross section of the thermoplastic carrier is a U shape, and the surface of the thermoplastic carrier is the inner surface of the U shape cross section, and the inner surface has a sidewall, and the pattern structure is configured on the sidewall.

10. The dental carrier of claim 8, wherein the accommodation space further has an accommodation space surface, and the thermoplastic carrier further has an outer surface, and the outer surface is partly adhered to the accommodation space surface, or the outer surface is totally fixed to the accommodation space surface by the exterior and a frictional force.
